(19) United States
(12) Patent Application Publication
(10) Pub. No.: US 2017/0361840 A1
(43) Pub. Date: Dec. 21, 2017

(54) AFTERMARKET CONTROLS FOR VEHICLES RETROFITTED WITH A NON-ORIGINAL POWERTRAIN

(71) Applicant: Robert VALENTINE, Glenwood Landing, NY (US)

(72) Inventor: Robert VALENTINE, Glenwood Landing, NY (US)

(21) Appl. No.: 15/629,323

(22) Filed: Jun. 21, 2017

Related U.S. Application Data
(60) Provisional application No. 62/352,648, filed on Jun. 21, 2016.

(51) Int. Cl. B60W 30/14

(52) U.S. Cl. CPC B60W 30/143; B60W 2720/10; B60W 2520/10; B60W 2540/12

(57) ABSTRACT

Aftermarket control kits, systems, and methods are operable for use in a vehicle retrofitted with a non-original powertrain having an OEM engine control module and without an OEM body control module. A kit includes, for example, an aftermarket control module operably connectable to the non-original powertrain via a vehicle communication bus in the retrofitted vehicle without the body control module, and the aftermarket control module is adapted to receive control signals from a driver activatable control switch and provide data via the vehicle communication bus so that the non-original powertrain without the body control module is operable to operate the vehicle in response to the driver activatable control signals. The aftermarket control module may be an aftermarket cruise control module, an aftermarket manumatic transmission control module, or a combination aftermarket cruise control module and manumatic transmission control module.

### CLAIM TO PRIORITY

This application claims the benefit of U.S. Provisional Application No. 62/352,648, filed Jun. 21, 2016, entitled “Aftermarket Cruise Control For Vehicles Retrofitted With Non-Original Powertrains,” which application is hereby incorporated herein in its entirety by reference.

### TECHNICAL FIELD

The present disclosure relates generally to aftermarket vehicle controls, and more particularly to aftermarket controls, such as aftermarket cruise controls and/or aftermarket manumatic transmission controls, for vehicles retrofitted with a non-original powertrain.

### BACKGROUND

A feature on many current vehicles is automatic vehicle speed control, often referred to as cruise control. Cruise control maintains a vehicle's forward motion at a specific speed chosen by a driver regardless of varying road conditions.

FIG. 1 illustrates a portion of an original equipment manufacturer (OEM) powertrain 100, such as found in General Motor vehicles since 2005, which employs drive-by-wire technology where a throttle pedal 120 is not physically connected to an engine throttle actuator 140. Instead, accelerator pedal 120 provides an input to an OEM engine control module 130, which OEM engine control module 130 then controls electronic throttle actuator 140 such as via an electric motor. In the OEM powertrain, an OEM body control module 160 is responsible for monitoring and/or controlling various electronic accessories 170 in a vehicle such as central locking, power windows, power mirrors, air conditioning, etc., as well as for use in implementing cruise control. The OEM engine control module and the OEM body control module communicate over a controller area network (CAN) 180, e.g., the vehicle communication link or the vehicle data bus. A cruise control switch 150, for use by a driver to operate cruise control, is connected to OEM body control module 160. The OEM engine control module stores cruise control algorithms for use in controlling throttle actuator 140 based on data from the OEM body control module. The OEM engine control module, and the OEM body control module operably connected to the electronic accessories, operate together in implementing cruise control in the vehicle in response to driver activation of the function control switch.

Often, in the automotive restoration, older vehicles are retrofitted with newer powertrains such as engines, transmissions, and related support systems.

FIG. 2 illustrates an aftermarket cruise control system 300 for use with an older vehicle retrofitted with a newer powertrain 200 having drive-by-wire technology. Aftermarket cruise control system 300 includes an aftermarket cruise control module 320 and a cruise control switch 350. Aftermarket cruise control module 320 operably connects to an OEM engine control module 230 and to a throttle pedal 220. Aftermarket cruise control module 320 receives and monitors vehicle speed via a CAN 280 from the OEM engine control module and provides simulated throttle petal outputs to the OEM engine control module to effect a cruise control feature in the vehicle.

Another feature on many current vehicles is manumatic transmission control. General Motors offers a TAPshift™ technology. This feature allows the operator to override the automatic selection of transmission forward gear ratios by the transmission control module of an electronically controlled automatic transmission.

FIG. 7 illustrates a portion of an original equipment manufacturer (OEM) powertrain 1000 having manumatic transmission control. The manumatic transmission control is implemented by an analog gear control switch 1850 for use by a driver. Analog gear control switch 1850 is operably connected to a transmission control module 1800, which transmission control module 1800 is operably connected to an OEM engine control module 1030 via a controller area network (CAN) 1080. In this illustrated portion of a powertrain, the user activated analog gear control commands are provided directly to the transmission control module 1800. A driver gear indicator display 1900 is operably connected to an OEM body control module 1060.

FIG. 8 illustrates a portion of another original equipment manufacturer (OEM) powertrain 2000 having manumatic transmission control. The manumatic transmission control is implemented by an analog gear control switch 2850 for use by a driver. Analog gear control switch 2850 is operably connected to a body control module 2060, which communicated via a controller area network (CAN) 2080 to an OEM transmission control module 2800 for manually effecting gear selection. A driver gear indicator display 2900 is operably connected to an OEM body control module 2060.

FIG. 9 illustrates a portion of an original equipment manufacturer (OEM) powertrain 3000 having analog manumatic transmission control. An aftermarket gear control switch 3855 is operably connectable to an OEM transmission control module 3800. In this illustrated portion of a powertrain, the user activated analog gear control commands are provided directly to the transmission control module 3800, i.e., the aftermarket gear control switch is not interfaced via a communication area network (CAN) 3180 to the transmission control module. In addition, a driver gear indicator/display is not provided.

### SUMMARY

Shortcomings of the prior art are overcome and additional advantages are provided through the provision of, in one embodiment, an aftermarket control kit for use in a vehicle retrofitted with a non-original powertrain. The non-original powertrain is configured for operation with an engine control module, a transmission control module, and a body control module. The kit is operable to effect control of the non-original powertrain without the body control module in the retrofitted vehicle. The kit includes, for example, an aftermarket control module operably connectable to the non-original powertrain via a vehicle communication bus in the retrofitted vehicle without the body control module, and the aftermarket control module adapted to receive control signals from a driver activatable control switch and provide data via the vehicle communication bus so that the non-original powertrain without the body control module is operable to operate the vehicle in response to the driver activatable control signals.

In another embodiment, the kit may include the aftermarket control module being an aftermarket cruise control module, and the aftermarket cruise control module operably connectable to the engine control module of the non-original powertrain via the vehicle communication bus in the retrofitted vehicle without the body control module, and the aftermarket cruise control module adapted to receive the control signals from the control switch being a cruise control switch and provide data via the vehicle communication bus to the engine control module so that the engine control module of the non-original powertrain without the body control module is operable to control an electronic throttle actuator of the non-original powertrain to operate the vehicle under cruise control.

In another embodiment, the kit may include the aftermarket control module being an aftermarket manumatic transmission control module, and the aftermarket manumatic transmission control module operably connectable to the transmission control module of the non-original powertrain via the vehicle communication bus in the retrofitted vehicle without the body control module, and the aftermarket manumatic transmission control module adapted to receive the control signals from the control switch being a gear control switch and provide data via the vehicle communication bus to the transmission control module so that the transmission control module of the non-original powertrain without the body control module is operable to operate the vehicle under driver control of the gear selection.

In another embodiment, an aftermarket control system is provided for use in a vehicle retrofitted with a non-original powertrain. The non-original powertrain is configured for operation with an engine control module, a transmission control module, and a body control module. The system is operable to effect control of the non-original powertrain without the body control module in the retrofitted vehicle. The system includes, for example, an aftermarket control module operably connectable to the non-original powertrain via a vehicle communication bus in the retrofitted vehicle without the body control module, a driver activatable control switch operably connectable to the aftermarket control module and positionable in the vehicle for access by a driver in the vehicle, a connector configured to connect the aftermarket control module to the vehicle communication bus of the vehicle, and the aftermarket control module adapted to receive control signals from the driver activatable control switch and provide data via the vehicle communication bus so that the non-original powertrain without the body control module is operable to operate the vehicle in response to the driver activatable control signals.

In another embodiment, the system may include the aftermarket control module being an aftermarket cruise control module, the aftermarket cruise control module operably connectable to the engine control module of the non-original powertrain via the vehicle communication bus in the retrofitted vehicle without the body control module, the driver activatable control switch being a cruise control switch, and the aftermarket cruise control module adapted to receive the control signals from the cruise control switch and provide data via the vehicle communication bus to the engine control module so that the engine control module of the non-original powertrain without the body control module is operable to control an electronic throttle actuator of the non-original powertrain to operate the vehicle under cruise control.

In another embodiment, the system may include the aftermarket control module being an aftermarket manumatic transmission control module, the aftermarket manumatic transmission control module operably connectable to the transmission control module of the non-original powertrain via the vehicle communication bus in the retrofitted vehicle without the body control module, the driver activatable control switch being a gear control switch, and the aftermarket manumatic transmission control module adapted to receive the control signals from the gear control switch and provide data via the vehicle communication bus to the transmission control module so that the transmission control module of the non-original powertrain without the body control module is operable to operate the vehicle under driver control of the gear selection.

In another embodiment, a method is provided for effecting control in a vehicle retrofitted with a non-original powertrain. The non-original powertrain is configured for operation with an engine control module, a transmission control module, and a body control module. The method is operable to effect control of the vehicle retrofitted with the non-original powertrain without the body control module. The method includes, for example, receiving, by one or more processor, one or more control signals in response to driver activation of a control switch, and forwarding, by the one or more processor, data via a vehicle communication bus so that the non-original powertrain without the body control module is operable to operate the vehicle in response to the driver activatable control signals.

In another embodiment, the method may include the receiving including receiving, by the one or more processor, the one or more control signals in response to driver activation of a cruise control switch, and the forwarding including forwarding, by the one or more processor, the data via the vehicle communication bus to an engine control module so that the engine control module is operable to control an electronic throttle actuator of the non-original powertrain to operate the vehicle under cruise control.

In another embodiment, the method may include the receiving including receiving, by the one or more processor, the one or more control signals in response to driver activation of a gear control switch, and the forwarding including forwarding, by the one or more processor, the data to a transmission control module so that the transmission control module is operable to operate the vehicle under driver control of the gear selection.

### DRAWINGS

The foregoing and other features, aspects and advantages of this disclosure will become apparent from the following detailed description of the various aspects of the disclosure taken in conjunction with the accompanying drawings, wherein:

FIG. 1 is a diagrammatic illustration of a portion of a prior art OEM powertrain for a vehicle having cruise control;

FIG. 2 is a diagrammatic illustration of a prior art OEM powertrain along with a aftermarket cruise control system for use in an older vehicle retrofitted with the newer OEM powertrain;

FIG. 3 is a diagrammatic illustration of a prior art OEM powertrain along with an aftermarket cruise control system according to an embodiment of the present disclosure for use in an older vehicle retrofitted with the newer OEM powertrain;

FIG. 4 is a diagrammatic illustration of cruise control switch of FIG. 3;

FIG. 5 is a block diagram of the aftermarket cruise control module of FIG. 3;

FIG. 6 is a flowchart of a method for controlling vehicle speed in a vehicle according to an embodiment of the present disclosure;

FIG. 7 is a diagrammatic illustration of a portion of a prior art OEM powertrain for a vehicle having manumatic transmission control;

FIG. 8 is a diagrammatic illustration of a portion of another prior art OEM powertrain for a vehicle having manumatic transmission control;

FIG. 9 is a diagrammatic illustration of a prior art OEM powertrain along with a manumatic transmission control according to an embodiment of the present disclosure for use in an older vehicle retrofitted with the newer OEM powertrain;

FIG. 10 is a diagrammatic illustration of a prior art OEM powertrain along with an aftermarket manumatic transmission control system according to an embodiment of the present disclosure for use in an older vehicle retrofitted with the newer OEM powertrain;

FIG. 11 is a diagrammatic illustration of manumatic transmission control switch of FIG. 10;

FIG. 12 is a block diagram of the aftermarket manumatic transmission control module of FIG. 10;

FIG. 13 is a flowchart of a method for controlling shifting of an automatic transmission in a vehicle according to an embodiment of the present disclosure;

FIG. 14 is a diagrammatic illustration of a prior art OEM powertrain along with an aftermarket manumatic transmission control system according to an embodiment of the present disclosure for use in an older vehicle retrofitted with the newer OEM powertrain; and

FIG. 15 is a flowchart of a method for controlling shifting of an automatic transmission in a vehicle according to an embodiment of the present disclosure;

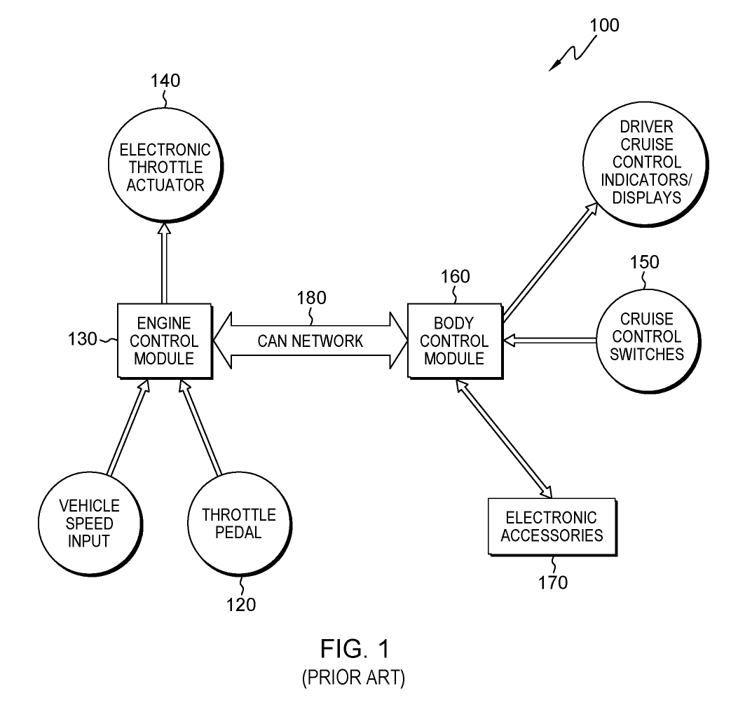

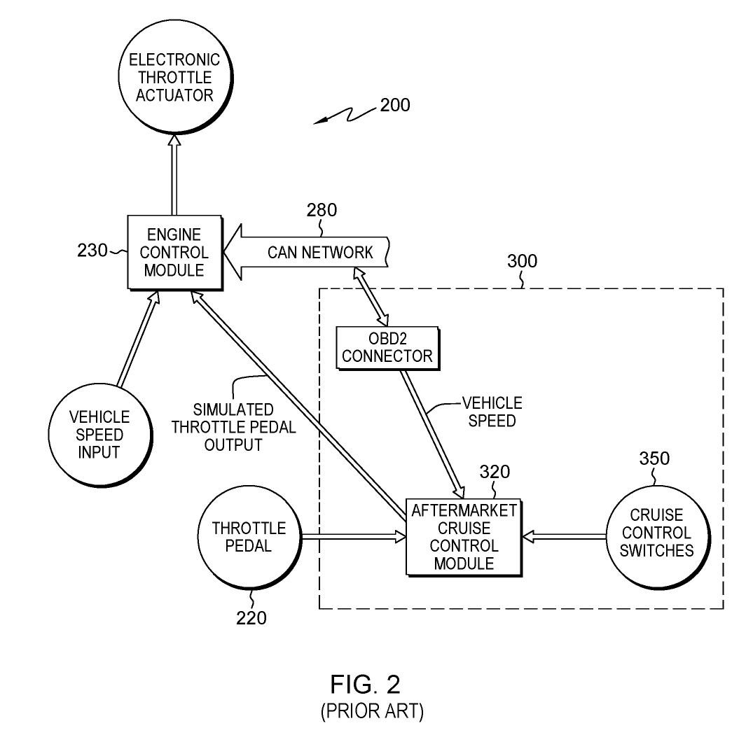

### DETAILED DESCRIPTION

Embodiments of the present disclosure and certain features, advantages, and details thereof, are explained more fully below with reference to the non-limiting examples illustrated in the accompanying drawings. Descriptions of well-known materials, processing techniques, etc., are omitted so as not to unnecessarily obscure the disclosure in detail. It should be understood, however, that the detailed description and the specific examples, while indicating embodiments of the present disclosure, are given by way of illustration only, and not by way of limitation. Various substitutions, modifications, additions, and/or arrangements, within the spirit and/or scope of the underlying inventive concepts will be apparent to those skilled in the art from this disclosure.

The present disclosure is directed to aftermarket cruise control kits and systems for use in, for example, effecting cruise control in vehicles retrofitted with non-original powertrains. The aftermarket cruise control kits and systems of the present disclosure allow, for example, retrofitting a newer powertrain such as a General Motor powertrain since 2005 into an older vehicle such as a 1960's or 1970's vehicles, as well as earlier or later vehicles, and providing the retrofitted vehicle with cruise control. It will be appreciated that the technique of the present disclosure may be employed with other different manufacturer of powertrains retrofitted in other vehicles.

The technique of the present disclosure allows using the stored factory cruise control algorithms in the OEM engine control module of a non-original powertrain for use in controlling a throttle actuator to effect cruise control in the vehicle retrofitted with the non-original powertrain. The aftermarket cruise control kits and systems of the present disclosure overcome the problem of an OEM engine control module and an OEM body control module in the retrofitted vehicle being unsatisfactory in providing cruise control in the retrofitted vehicle since the additional electronic accessories are not present in the retrofitted vehicle. In some embodiments, the aftermarket cruise control kits and systems of the present disclosure may be selectably operable or programmable for use in a plurality of different manufacturer powertrains.

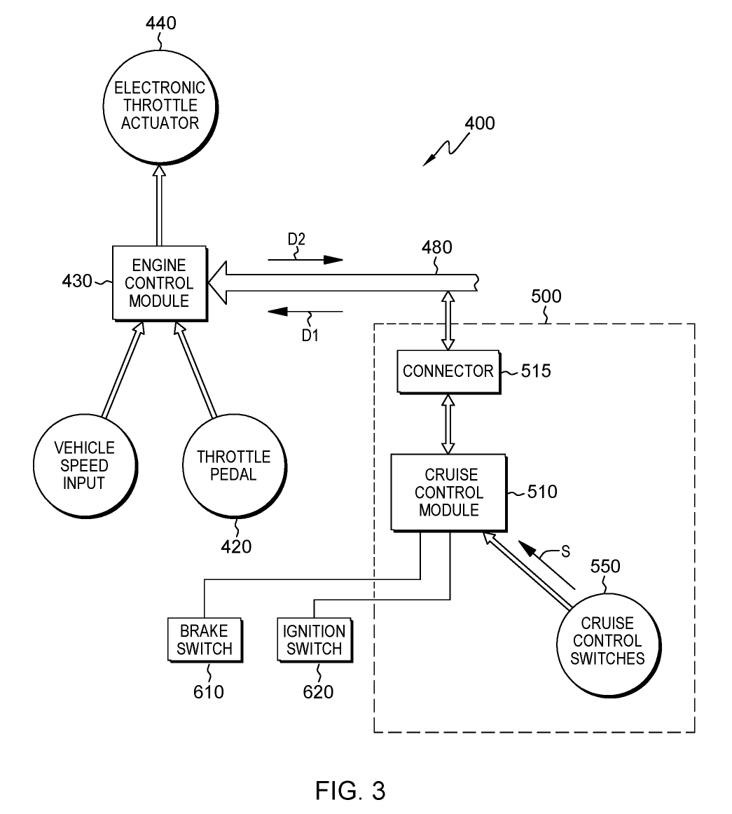

FIG. 3 illustrates a portion of a non-original powertrain having an aftermarket cruise control system 500 according to the present disclosure retrofitted in a vehicle. Aftermarket cruise control system 500 is operable for effecting cruise control in the retrofitted vehicle with the non-original powertrain having an OEM engine control module 430 with factory installed algorithms for controlling engine throttle actuator 440 under cruise control and without use of the OEM body control module. In this illustrated embodiment, aftermarket cruise control system 500 may include an aftermarket cruise control module 510 and a function control switch such as a cruise control switch 550.

Aftermarket cruise control module 510 may be operably connectable to OEM engine control module 430 via a vehicle communication bus 480 such as a powertrain's controller area network (CAN). For example, aftermarket cruise control module 510 may be connected to vehicle communication bus 480 using a connector 515 such as an OBD-II diagnostic connector connectable to a diagnostic port connected to the vehicle communication bus. It will be appreciated that the aftermarket cruise control module of the present disclosure may be operably connected to the vehicle communication bus via a non-used port for normally connecting to a body control module, or via other suitable connections, for example, via the vehicle communication bus or directly to the OEM engine control module.

Cruise control switch 550 is operably connected to aftermarket cruise control module 510. The cruise control switch may be positioned in the vehicle for access by a driver of the vehicle for activating cruise control in the vehicle. For example, the cruise control switch may be operably connected to the aftermarket cruise control module with wires or operably wirelessly connected to the aftermarket cruise control module. In some embodiments, an aftermarket cruise control kit may include a cruise control switch connectable to an aftermarket cruise control module. In other embodiments, an aftermarket cruise control module may be operably connectable to an existing cruise control switch in the vehicle being retrofitted.

Aftermarket cruise control module 510 may also be operably connected to a brake switch 610 in the retrofitted vehicle and/or to an ignition switch 620 in the retrofitted vehicle.

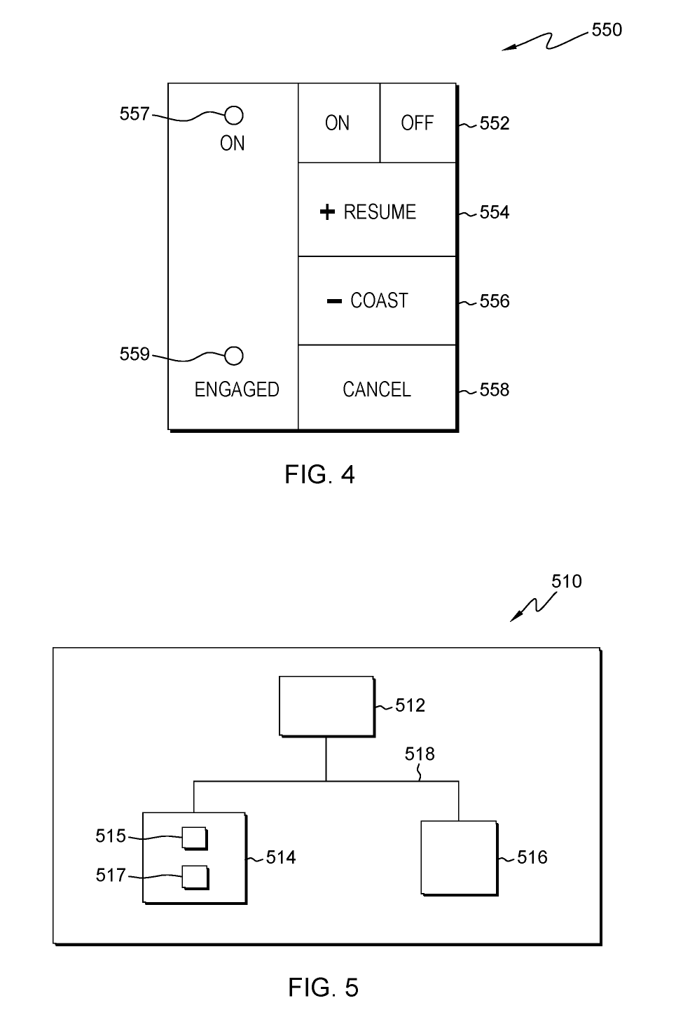

As shown in FIG. 4, cruise control switch 550 allows a driver to select the desired operation of the vehicle operating under cruise control. For example, cruise control switch 550 may include an ON/OFF button 552, a Set/Resume button 554, a Decrease/Coast button 556, and a Cancel button 558. Cruise control switch 550, along with aftermarket cruise control module 510 and OEM engine control module 430, may be operable to effect various cruise control operations as described in greater detail below.

As shown in FIG. 5, the components of aftermarket cruise control module 510 may include, but are not limited to, one or more processors or processing units 512, a memory 514, one or more input/output devices or input/output interfaces 516, and a bus 518 that couples the various components together. By way of example, and not limitation, one or more processors or processing units 512 may be a PIC microchip 16F84 or other suitable microprocessor. Memory 514 can include computer readable media in the form of volatile memory, such as random access memory (RAM), and or other removable/non-removable, volatile/non-volatile computer system storage media. Input/output devices 516 may interface with or communication with one or more external devices such as cruise control switch 550 and CAN 480 (FIG. 3). Cruise control switch 550 may be an aftermarket cruise control switch which provides different outputs compared to an OEM cruise control switch operable with the OEM power train.

Additional inputs to aftermarket cruise control module 510 via input/output interfaces 516 may include a brake signal. For example, a signal may be received from a brake switch operably connected to the brake pedal for use in monitoring if the brake pedal is applied or released. Electrical power for aftermarket cruise control system 500 may be operably provided by connecting the microcontroller to the vehicle ignition switch and ground.

In aftermarket cruise control module 510, one or more programs 515 may be stored in memory 514 by way of example, and not limitation, as well as an operating system, one or more application programs, other program modules. One or more databases or libraries 517 may be stored in memory 514 such as program data, e.g., data, codes or messages used for communicating control data to OEM engine control module 430 (FIG. 3) in response to activation of cruise control switch 550 (FIG. 4). Each of the operating system, one or more application programs, other program modules, and program data or some combination thereof, may include use in implementing cruise control. One or more programs 515 generally carry out the functions and/or methodologies of embodiments of the present disclosure as described herein.

The OEM engine control module also stores factory installed cruise control algorithms for use in controlling an electric motor or equivalent to actuate the engine throttle. As described below, aftermarket cruise control module 510 includes associated algorithms and data to receive inputs from the driver via cruise control switch 550 (FIG. 3) and provide outputs to OEM engine control module 430 (FIG. 3) for use in effecting the cruise control algorithms present in the OEM engine control module 430 (FIG. 3).

With reference to FIGS. 3 and 4, in operation, aftermarket cruise control module 510 monitors cruise control switch 550 for inputs, e.g., control signals, from the driver in connection with activation of cruise control. For example, ON/OFF button 552 of cruise control switch 550 may be operable to provide control signals to cruise control module 510 to turn the system on and off. Set/Resume button 554 may be operable to provide control signals to aftermarket cruise control module 510 to set or engage the cruise control to the current vehicle road speed. Holding the button may engage the resume function which brings the vehicle to the last set road speed. Pushing the button momentarily raises the vehicle road speed by a pre-set amount, for example, 1 mile per hour (mph). Decrease/Coast button 556 may be operable to provide control signals to aftermarket cruise control module 510 by pushing the button momentarily to reduce the vehicle road speed by a preset amount, for example, 1 mph. Holding the button may temporarily disengage the aftermarket cruise control system and allow the vehicle to slow down. When released the current speed will become the new set speed. Cancel button 558 may be operable to provide a signal to aftermarket cruise control module 510 to disengage the aftermarket cruise control system.

Cruise control switch 550 may also include a first light 557 such as an LED light for indicating to the driver the ON/OFF status of the system. A second light 559 such as an LED light may indicate to the driver when cruise control is engaged. For example, light 557 may be illuminated upon pressing the ON/OFF button and remain illuminated to indicate the system is ready for use. Pressing the Set/Resume button may illuminate light 559 to indicate that cruise control is engaged. Pressing the Decrease/coast button may turn off light 559 during coast. Cancel button 558 may also turn off any light used to indicate the system was engaged. The cruise control switch may vary in appearance and form, and may include any suitable original equipment manufacturer cruise control switch and aftermarket cruise control switch.

If the requirements to enable cruise control have been met and function controls signals S (FIG. 3) received by aftermarket cruise control module 510 from cruise control switch 550, aftermarket cruise control module 510 provides corresponding messages or data D1 to OEM engine control module 430. For example in a CAN bus environment of a vehicle, the aftermarket cruise control module and the OEM engine control module can send data D1 (FIG. 3) and receive data D2 (FIG. 3) as defined in the CAN standards. Aftermarket cruise control module 510 may employ corresponding OEM established message identifiers and message payload definitions. Each module transmits messages on pre-set intervals and other modules listen for and use messages they are programmed to interact on. As described above, contained in the OEM engine control module's operating program are the algorithms for cruise control, a system that maintains the vehicle's road speed at a driver's requested speed.

When a driver selects the ON button, aftermarket cruise control module 510 forwards data such as one or more messages, codes, or data regarding the selected ON button over vehicle communication bus 480 to OEM engine control module 430 requesting cruise control be enabled for operation. If requirements to enable cruise control have been met, OEM engine control module 430 will forward data such as a message over vehicle communication bus 480 to aftermarket cruise control module 510 indicating that cruise control has been activated and is ready for the driver to put into operation. The aftermarket cruise control module 510 may turn on light 557 to let the driver know the system is activated.

When the driver reaches their desired speed, the driver may press the SET button to engage cruise control. Aftermarket cruise control module 510 then forwards data such as one or more messages or codes regarding the selected SET button over vehicle communication bus 480 to the OEM engine control module 430 to request cruise control engagement. If all conditions have been met, OEM engine control module 430 assumes control of the engine throttle and maintains the set vehicle speed. OEM engine control module 430 forwards a message or code over vehicle communication bus 480 to aftermarket cruise control module 510 that cruise control has been engaged. Aftermarket cruise control module 510 may turn on the engaged indicator light 559 to let the driver know cruise control is engaged.

If the driver wants to increase the vehicle speed, the driver can activate Set/Resume button. Aftermarket cruise control module 510 forwards data such as one or more messages or codes regarding the selected increase over vehicle communication bus 480 to OEM engine control module 430 requesting speed increase. If conditions are met, OEM engine control module 430 will increase the vehicle speed. If the driver wants to decrease the vehicle speed, the driver can activate the Decrease/Coast button. Aftermarket cruise control module 510 forwards data such as one or more messages or codes regarding the selected decrease over vehicle communication bus 480 to OEM engine control module 430 requesting vehicle speed decrease. If conditions are met, OEM engine control module 430 decreases the vehicle speed.

If the driver wants to disengage cruise control, the driver can activate the Cancel button or press the brake pedal. Either causes aftermarket cruise control module 510 to forward data such as one or more messages or codes to deactivate cruise control over vehicle communication bus 480 to OEM engine control module 430 requesting disengagement of cruise control and turn off the active indicator light 559 (FIG. 4). The cruise control system remains ready for another activation.

If the driver wants to turn off the cruise control system, the driver activates the OFF button. Aftermarket cruise control module 510 forwards data such as one or more messages or codes requesting the system be turned off over vehicle communication bus 480 to OEM engine control module 430. Aftermarket cruise control module 510 turns off light 557 (FIG. 4) and light 559 (FIG. 4).

As will be appreciated, in the technique of the present disclosure, the aftermarket cruise control module is operable to effect cruise control in the retrofitted vehicle without the OEM body control module and without the need for or the presence and connection to electronic accessories such as central locking, power windows, power mirrors, air conditioning, etc.

With reference to FIG. 3, in this illustrated embodiment, OEM engine control module 430 monitors for conditions to allow cruise control, such as:
1. Vehicle is in a forward gear range;
2. The service brake is in the released position;
3. The parking brake is released;
4. A secondary brake pedal activation signal has been received from aftermarket cruise control module 510;
5. The vehicle is moving forward in excess of a lower speed limit;
6. No powertrain or platform failures that would prevent cruise control are present; and
7. The operator has indicated they want the cruise control system operational.

Once the above conditions are met:
1. The operator manually achieves the desired vehicle road speed;
2. The Set/Resume button is activated momentarily;
3. Aftermarket cruise control module 510 sends a message to OEM engine control module 430 indicating the set/resume switch has been activated; and
4. OEM engine control module 430 cruise control algorithm takes over, e.g., controls the engine control throttle, and maintains the vehicle speed.

When cruise control is no longer wanted by the driver, the following can occur:
1. The operator turns off cruise control thru the On/Off switch; and
2. Aftermarket cruise control module 510 sends a message to OEM engine control module 430 to turn off cruise control.
1. The operator presses the Cancel button; and
2. Aftermarket cruise control module 510 sends a message to OEM engine control module 430 indicating the switch has been activated and OEM engine control module 430 disengages cruise control.
1. The operator presses the service brake;
2. OEM engine control module 430 receives a brake activation and disengages cruise control; and
3. Aftermarket cruise control module 510 sends a secondary brake activation message to OEM engine control module 430 which then cancels cruise control.

For example, aftermarket cruise control module 510 may be operable with an OEM powertrain and CAN bus environment, such as a General Motors powertrain since 2005, which may establish the following data messages:
“<message identifier>:<message payload>”
   “0x1AA:<cruise control switch status>” may be transmitted periodically such as every 100 milliseconds by aftermarket cruise control module 510. Valid conditions may be:
1. Cruise control system enable/disable request.
2. Set switch activated.
3. Cancel switch activated.
   0x0BB:<cruise control system status>. Valid conditions may be:
1. “System Ok”—cruise control may be engaged by driver.
2. “System Fault”—OEM engine control module detects a condition preventing cruise control operation.
3. “Speed Set At X”—OEM engine control module has engaged cruise control and will keep vehicle at speed X.

An exemplary scenario may be as follows:
1. The driver turns on the cruise control “on/off switch.”
2. Aftermarket cruise control module 510 updates message 0x1AA with content “cruise control system enable” to OEM engine control module 430.
3. OEM engine control module 430 runs routines to check cruise control may be safely enabled.
4. If cruise control may be enabled, OEM engine control module 430 updates message 0x0BB to “System Ok.”
5. Aftermarket cruise control module 510 receives message 0x0BB and decodes “System Ok.”
6. Aftermarket cruise control module 510 turns on an indicator to the driver that cruise control is ready for use.

The driver accelerates the vehicle to 50 mph. At that point, the driver may press the “Set” button.
1. Aftermarket cruise control module 510 receives the input and updates message 0x1AA with content “Set switch activated.”
2. OEM engine control module 430 receives message 0x1AA and decodes “Set switch activated.”
3. OEM engine control module 430 cruise control algorithm adjusts engine power to maintain 50 mph without input from the throttle pedal.
4. OEM engine control module 430 updates message 0x0BB with “Speed Set at 50.”
5. Aftermarket cruise control module 510 receives message 0x0BB, decodes “Speed Set at 50”. It may turn on an indicator to the driver that cruise control is operational and also display a message with the set vehicle speed.

The driver presses the Cancel button.
1. Aftermarket cruise control module 510 receives the input and updates message 0x1AA with content “Cancel switch activated”.
2. OEM engine control module 430 receives message 0x1AA and decodes “Cancel switch activated”.
3. OEM engine control module 430 cruise control algorithm stops maintaining vehicle speed.
4. OEM engine control module 430 updates message 0x0BB with “System Ok.”
5. Aftermarket cruise control module 510 receives message 0x0BB with “System Ok.” It sets any indicators or messages needed to inform the driver cruise control has been canceled.

It will be appreciated that the cruise control module may send data or messages to the OEM engine control module in response to the driver activated cruise control switch so that the OEM engine control module is receptive for operation of cruise control at a desired time by the driver.

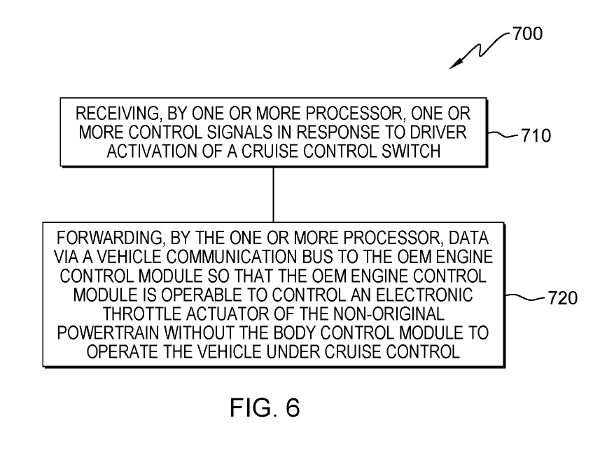

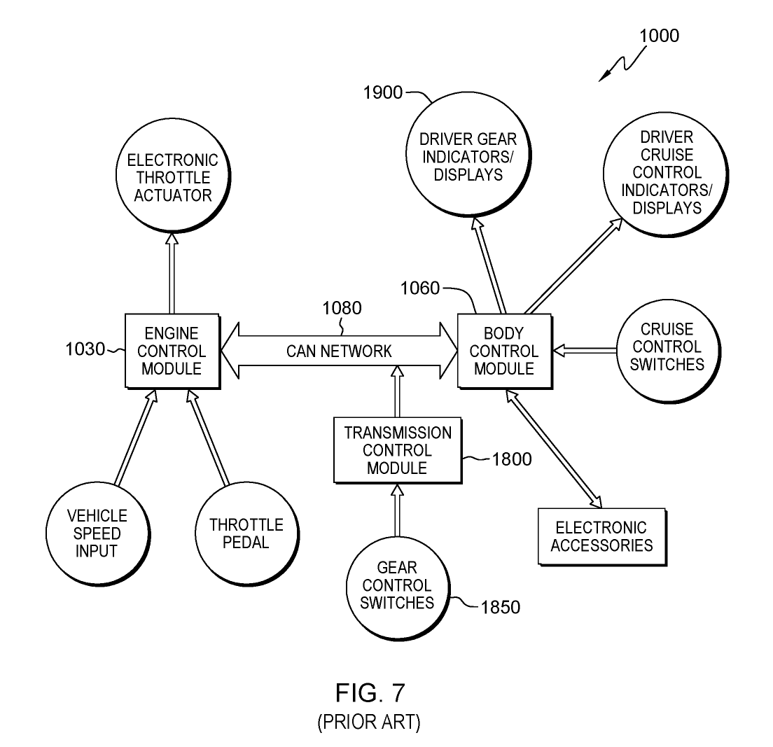

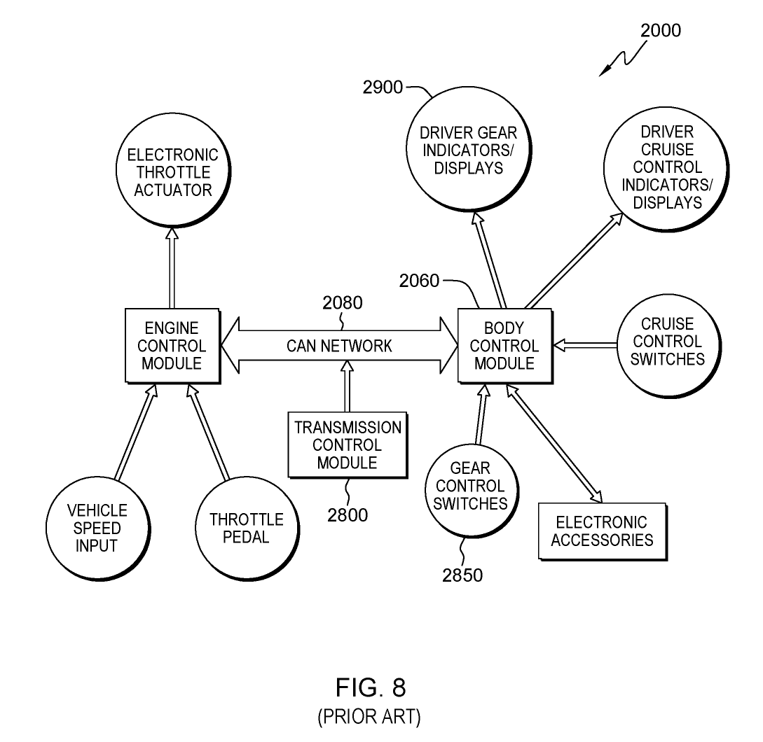

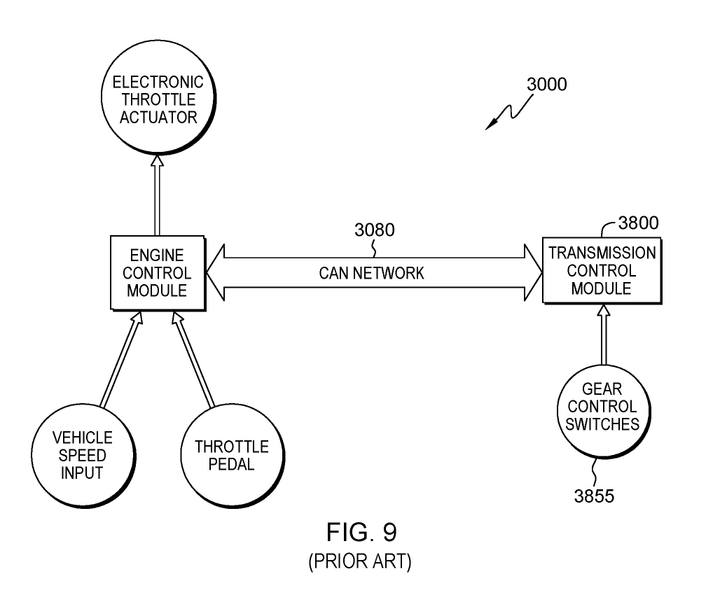

FIG. 6 illustrates a method 700 for effecting cruise control in a vehicle retrofitted with a non-original powertrain, the non-original powertrain configured for operation with an OEM engine control module and an OEM body control module, and the method operable to effect cruise control in the vehicle retrofitted with the non-original powertrain without the OEM body control module. Method 700 includes at 710 receiving, by one or more processor, one or more control signals in response to driver activation of a cruise control switch, and at 720 forwarding, by the one or more processor, data via a vehicle communication bus to the OEM engine control module so that the OEM engine control module is operable to control an electronic throttle actuator of the non-original powertrain without the body control module to operate the vehicle under cruise control.

In other embodiments of the present disclosure, an aftermarket cruise control module may be configurable so as to be adapted for use in more than one different manufacturers of non-original powertrains. An aftermarket cruise control module may be selectably setup by an installer of an aftermarket cruise control module in a vehicle retrofitted with a non-original powertrain. For example, such an aftermarket cruise control module may include memory with separate data or libraries for use with different OEM engine control modules by different manufactures such as General Motors and Ford Motor Company. Upon installation, such an aftermarket cruise control module may be operably sent up or coded to the desired OEM engine control module.

From the present description, the technique of the present disclosure provides aftermarket cruise control kits and systems that overcome the problem of an OEM engine control module and an OEM body control module in a retrofitted vehicle having a non-original powertrain being unsatisfactory in providing cruise control in the retrofitted vehicle since the additional electronic accessories are not present in the retrofitted vehicle. Such a technique provides reduced components compared to prior attempts employing an actuator connected to a throttle pedal for effecting cruise control.

The present disclosure is also directed to aftermarket manumatic transmission control kits and systems for use in, for example, in allowing an operator to manually override the automatic selection of transmission forward gear ratios by the transmission control module of an electronically controlled automatic transmission in vehicles retrofitted with non-original powertrains. The aftermarket manumatic transmission control kits and systems of the present disclosure allow, for example, retrofitting a newer powertrain such as a General Motor powertrain since 2005 into an older vehicle such as a 1960's or 1970's vehicles, as well as earlier or later vehicles, and providing the retrofitted vehicle with manumatic transmission control such as TAPshift™. It will be appreciated that the technique of the present disclosure may be employed with other different manufacturer of powertrains retrofitted in other vehicles.

The technique of the present disclosure allows using the stored factory transmission control algorithms in the OEM transmission control module of a non-original powertrain to effect manumatic transmission operation in the vehicle retrofitted with the non-original powertrain. The aftermarket manumatic kits and systems of the present disclosure overcome the problem of an OEM transmission control module and an OEM body control module in the retrofitted vehicle being unsatisfactory in providing manumatic transmission operation in the retrofitted vehicle since the additional electronic accessories are not present in the retrofitted vehicle. In some embodiments, the manumatic transmission operation kits and systems of the present disclosure may be selectably operable or programmable for use in a plurality of different manufacturer powertrains.

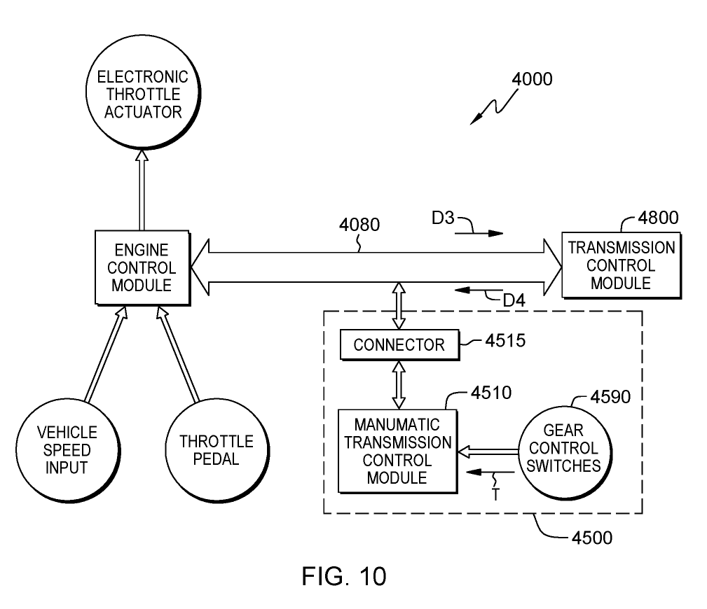

FIG. 10 illustrates a portion of a non-original powertrain 4000 having aftermarket manumatic transmission control system 4500 according to the present disclosure retrofitted in a vehicle. Aftermarket manumatic transmission control system 4500 is operable for effecting manumatic transmission operation in the retrofitted vehicle with the non-original powertrain having an OEM transmission control module 4800 with factory installed algorithms for controlling manumatic transmission operation and without use of the OEM body control module. In this illustrated embodiment, aftermarket manumatic transmission control system 4500 may include an aftermarket manumatic transmission control module 4510 and a function control switch such as a transmission gear selection switch or gear control switch 4590.

Aftermarket manumatic transmission control system 4500 may be operably connectable to OEM transmission control module 4800 via a vehicle communication bus 4080 such as a powertrain's controller area network (CAN). For example, aftermarket manumatic transmission control module 4510 may be connected to vehicle communication bus 4080 using a connector 4515 such as an OBD-II diagnostic connector connectable to a diagnostic port connected to the vehicle communication bus. It will be appreciated that the aftermarket manumatic transmission control module of the present disclosure may be operably connected to the vehicle communication bus via a non-used port for normally connecting to a body control module, or via other suitable connections, for example, via the vehicle communication bus or directly to the OEM engine control module.

Gear control switch 4590 is operably connected to aftermarket manumatic transmission control 4510. The gear control switch may be positioned in the vehicle for access by a driver of the vehicle for activating and controlling manumatic transmission operation in the vehicle. For example, the gear control switch may be operably connected to the aftermarket manumatic transmission control module with wires or operably wirelessly connected to the aftermarket manumatic transmission control module. In some embodiments, an aftermarket manumatic transmission control kit may include a gear control switch connectable to an aftermarket manumatic transmission control module. In other embodiments, an aftermarket manumatic transmission control module may be operably connectable to an existing gear control switch in the vehicle being retrofitted.

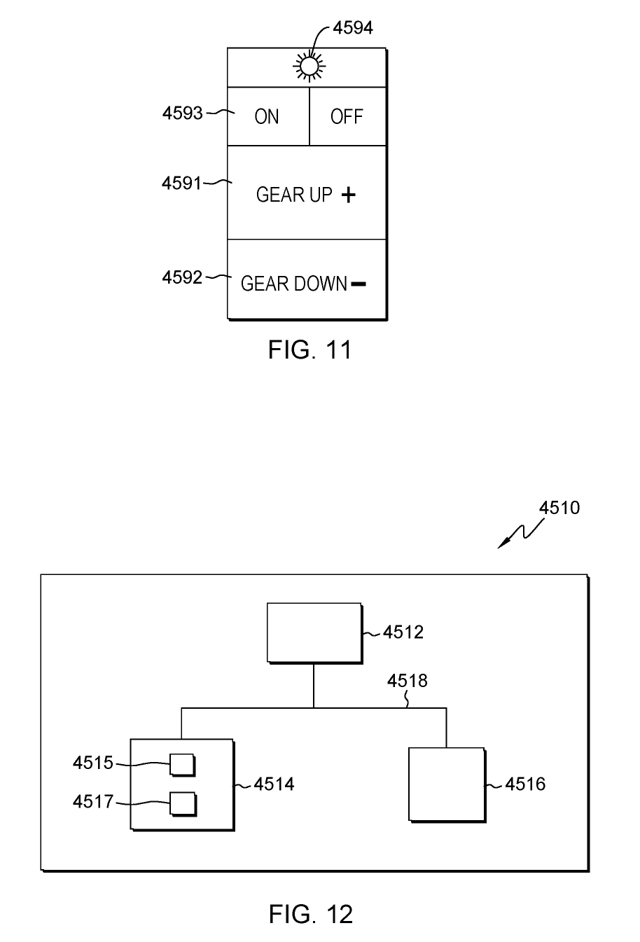

As shown in FIG. 11, gear control switch 4590 allows a driver to select the desired transmission forward gear or forward gear range operation of the vehicle operating a manumatic transmission mode. For example, gear control switch 4590 may include an ON/OFF button 4593, a Gear Up button 4591, and a Gear Down button 4592. Transmission gear control switch 4590, along with aftermarket manumatic transmission control module 4510, and OEM transmission control module 4800 may be operable to effect various manual transmission gear or gear range control operations as described in greater detail below.

As shown in FIG. 12, the components of aftermarket manumatic transmission control module 4510 may include, but are not limited to, one or more processors or processing units 4512, a memory 514, one or more input/output devices or input/output interfaces 4516, and a bus 5518 that couples the various components together. By way of example, and not limitation, one or more processors or processing units 4512 may be a PIC microchip 16F84 or other suitable microprocessor. Memory 4514 can include computer readable media in the form of volatile memory, such as random access memory (RAM), and or other removable/non-removable, volatile/non-volatile computer system storage media. Input/output devices 4516 may interface with or communication with one or more external devices such as aftermarket gear control switch 4590 and CAN 4080 (FIG. 10). Gear control switch 4590 may be an aftermarket gear control switch which provides different outputs compared to an OEM gear control switch operable with the OEM power train.

Electrical power for aftermarket manumatic transmission control system 4500 may be operably provided by connecting the microcontroller to the vehicle ignition switch and ground.

In aftermarket manumatic transmission control module 4510, one or more programs 4515 may be stored in memory 4514 by way of example, and not limitation, as well as an operating system, one or more application programs, other program modules. One or more databases or libraries 4517 may be stored in memory 4514 such as program data, e.g., data, codes or messages used for communicating control data to OEM transmission control module 4800 (FIG. 10) in response to activation of gear control switch 4590 (FIG. 11). Each of the operating system, one or more application programs, other program modules, and program data or some combination thereof, may include use in implementing manumatic transmission operation. One or more programs 4515 generally carry out the functions and/or methodologies of embodiments of the present disclosure as described herein.

The OEM transmission control module also stores factory installed manumatic transmission operation algorithms for use in controlling the vehicles automatic transmission. As described below, aftermarket manumatic transmission control module 4510 includes associated algorithms and data to receive inputs from the driver via gear control switch 4590 (FIG. 11) and provide outputs to transmission control module 4800 (FIG. 10) for use in effecting the manumatic transmission operation algorithms present in the OEM transmission control module 4800 (FIG. 10).

With reference to FIGS. 10 and 11, in operation, aftermarket manumatic transmission control module 4510 monitors gear control switch 4590 for inputs, e.g., control signals, from the driver in connection with activation of manumatic transmission operation. For example, ON/OFF button 4593 of gear control switch 4590 may be operable to provide control signals to manumatic transmission control module 510 to request the operation or cancellation of manumatic transmission mode. Gear Up button 4591 may be operable to provide control signals to aftermarket manumatic transmission control module 4510 to command the transmission to select a higher operating forward gear or gear range. Pushing Gear Up button 4591 momentarily raises the gear or gear range a pre-set amount, for example, 1 gear higher than the current gear. Gear Down button 4592 may be operable to provide control signals to aftermarket manumatic transmission control module 4510 by pushing the button momentarily to command the transmission to select a lower operating forward gear or gear range by a preset amount, for example, 1 gear lower than the current gear.

Gear control switch 4590 may also include a first light 4594, (FIG. 11) such as an LED light for indicating to the driver the ON/OFF status of the system. For example, light 4594 may be illuminated upon pressing the ON/OFF button and remain illuminated to indicate the transmission is operating in manumatic mode. Gear control switch 4590 may vary in appearance and form, and may include any suitable original equipment manufacturer gear control switch and aftermarket gear control switch

If the requirements to enable manumatic transmission operation have been met and function controls signals T (FIG. 10) received by aftermarket manumatic transmission control 4510 from gear control switch 4590, aftermarket manumatic transmission control module 4510 provides corresponding messages or data D3 to OEM transmission control module 4800. For example in a CAN bus environment of a vehicle, aftermarket manumatic transmission control module 4510 and the OEM transmission control module 4800 can send data D3 (FIG. 10) and receive data D4 (FIG. 10) as defined in the CAN standards. Aftermarket manumatic transmission control module 4510 may employ corresponding OEM established message identifiers and message payload definitions. Each module transmits messages on pre-set intervals and other modules listen for and use messages they are programmed to interact on. As described above, contained in the OEM transmission control module's operating program are the algorithms for manumatic transmission operation, a system that allows the override the automatic selection of transmission forward gear ratios by manually select the operating gear as in a manual transmission or range of forward gears for the transmission to use.

When a driver selects the ON button, aftermarket manumatic transmission control module 4510 forwards data such as one or more messages, codes, or data regarding the selected ON button over vehicle communication bus 4080 to OEM transmission control module 4800 requesting manumatic transmission mode be enabled for operation. If requirements to enable manumatic transmission mode have been met OEM transmission control module 4800 will forward data such as a message over vehicle communication bus 4080 to aftermarket manumatic transmission control module 4510 indicating that manumatic transmission mode has been activated and is ready for the driver to put into operation. The aftermarket manumatic transmission control module 4510 may turn on light 4594 to let the driver know the system is activated.

When the driver desires manumatic transmission mode the driver may press the ON/OFF button to request manumatic transmission mode. Aftermarket manumatic transmission control module 4510 then forwards data such as one or more messages or codes regarding the selected ON/OFF button over vehicle communication bus 4080 to the OEM transmission control module 4800 to request manumatic transmission mode. If all conditions have been met, OEM transmission control module 4800 stops normal selection of forward operating gear or gear ranges and awaits input from the driver via the gear control switch 4590. OEM transmission control module 4800 forwards a message or code over vehicle communication bus 4080 to aftermarket manumatic transmission control module 4510 that manumatic transmission mode has been engaged. Aftermarket manumatic transmission control module 4510 may turn on light 4594 to let the driver know manumatic transmission mode is active.

If the driver wants to increase the current transmission operating gear or gear range the driver can activate Gear Up button 4591. Aftermarket manumatic transmission control module 4510 forwards data such as one or more messages or codes regarding the selected increase over vehicle communication bus 470 to OEM transmission control module 4800 requesting an increased transmission operating gear or gear range. If conditions are met, OEM transmission control module 4800 will shift the transmission to a higher gear or gear range. If the driver wants to decrease the transmission operating gear or gear range, the driver can activate Gear Down button 4592. Aftermarket manumatic transmission control module 4510 forwards data such as one or more messages or codes regarding the selected decrease over vehicle communication bus 470 to OEM transmission control module 4800 requesting a decreased transmission operating gear or gear range. If conditions are met, OEM transmission control module 4800 decreases the transmission operating gear or gear range.

If the driver wants to turn off manumatic transmission mode, the driver activates the ON/OFF button. Aftermarket manumatic transmission control module 4510 forwards data such as one or more messages or codes requesting the mode be turned off over vehicle communication bus 4080 to OEM transmission control module 4800. Aftermarket manumatic transmission control module 4510 turns off light 4594 (FIG. 11).

As will be appreciated, in the technique of the present disclosure, the aftermarket manumatic transmission control module is operable to effect manumatic transmission mode in the retrofitted vehicle without the OEM body control module and without the need for or the presence and connection to electronic accessories such as central locking, power windows, power mirrors, air conditioning, etc.

With reference to FIG. 10, in this illustrated embodiment, OEM transmission control module 4800 monitors for conditions to allow manumatic transmission mode, such as:
1. Vehicle is in a forward gear range that allows for manumatic transmission mode;
2. No powertrain or platform failures that would prevent manumatic transmission mode are present; and
3. The operator has indicated they want manumatic transmission mode operational.

Once the above conditions are met:
1. The ON/OFF button is activated;
2. Aftermarket manumatic transmission control module 4510 sends a message to OEM transmission control module 4800 indicating manumatic transmission mode is active; and
3. OEM transmission control module 4800 manumatic transmission algorithm takes over, e.g., discontinuing normal gear or gear range changes and waiting for gear or gear range requests from the driver.

When manumatic transmission mode is no longer wanted by the driver, the following can occur:
1. The operator turns off manumatic transmission mode thru the On/Off switch; and
2. Aftermarket manumatic transmission module 4510 sends a message to OEM transmission control module 4800 to turn off manumatic transmission mode.
1. The operator changes the transmission shifter to a non-manumatic transmission position; and
2. The OEM transmission control module 4510 detects this change and turns off manumatic transmission mode.

For example, aftermarket manumatic transmission module 4510 may be operable with an OEM powertrain and CAN bus environment, such as a General Motors powertrain since 2005, which may establish the following data messages:
“<message identifier>:<message payload>”
   “0x0CC:<manumatic transmission mode switch status>” may be transmitted periodically such as every 100 milliseconds by aftermarket manumatic transmission module 4510. Valid conditions:
1. manumatic transmission mode ON/OFF request.
2. Gear Up activated; and
3. Gear Down activated.
   0x0DD:<manumatic transmission mode system status>. Valid conditions may be:
   1. “transmission mode”—the state of transmission operation normal or manumatic mode.
   2. “Current Operating Gear or Gear Range”—the current gear or gear range in use.
   3. “Shift Denied”—the OEM transmission control module 4800 determines that a driver requested gear or gear range is not acceptable for reasons including but not limited to damage to powertrain components. The OEM transmission control module 4800 will not change to the driver requested gear or gear range.

An exemplary scenario may be as follows:
1. Vehicle is in a forward gear range that allows for manumatic transmission mode.
2. The driver presses gear selection switch ON/OFF button.
3. Aftermarket manumatic transmission module 4510 updates message 0x1CC with content “manumatic transmission mode requested ” to OEM transmission control module 4800.
3. OEM transmission control module 4800 runs routines to check manumatic transmission mode may be safely enabled.
4. If manumatic transmission mode may be enabled, OEM transmission control module 4800 updates message 0x0DD to “manumatic transmission mode enabled.”
5. Aftermarket manumatic transmission module 4510 receives message 0x0DD and decodes “manumatic transmission mode enabled.
6. Aftermarket manumatic transmission module 4510 turns on an indicator to the driver that manumatic transmission mode is enabled.
7. Aftermarket manumatic transmission module 4510 may display a message to the driver indicating the current operating gear or gear range.

If the driver desires a higher operating gear or gear range, at that point, the driver may press the “Gear Up” button.
1. Aftermarket manumatic transmission module 4510 receives the input and updates message 0x1CC with content “Gear increase requested.”
2. OEM transmission control module 4800 receives message 0x1CC and decodes “Gear increase requested.”
3. OEM transmission control module 4800 manumatic transmission mode algorithm changes the transmission to a higher gear or gear range.
4. OEM transmission control module 4800 updates message 0x0DD with an updated “Current Operating Gear or Gear Range.”
5. Aftermarket manumatic transmission module 4510 receives message 0x0DD, decodes “Current Operating Gear or Gear Range.” It may display a message to the driver indicating the new operating gear or gear range.

The driver presses the On/Off button.
1. Aftermarket manumatic transmission module 4510 receives the input and updates message 0x1CC with content “normal transmission mode requested.”
2. Transmission control module 4800 receives message 0x1CC and decodes “normal transmission mode requested.”
3. OEM transmission control module 4800 manumatic transmission mode algorithm stops manumatic transmission mode.
4. OEM transmission control module 4800 updates message 0x1DD with “normal transmission mode engaged.”
5. Aftermarket manumatic transmission module 4510 receives message 0x1DD with “normal transmission mode engaged.” It sets any indicators or messages needed to inform the driver manumatic transmission mode has been canceled.

It will be appreciated that the cruise control module may send data or messages to the OEM transmission control module in response to the driver activated gear or gear range switch so that the OEM transmission control module is receptive for operation of manumatic transmission mode at a desired time by the driver.

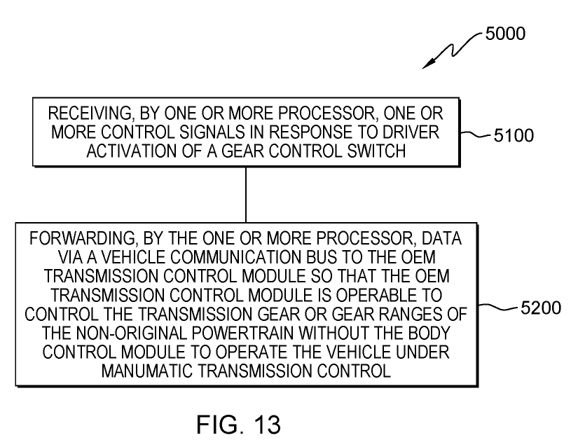

FIG. 13 illustrates a method 5000 for effecting manumatic transmission mode in a vehicle retrofitted with a non-original powertrain, the non-original powertrain configured for operation with an OEM transmission control module and an OEM body control module, and the method operable to effect manumatic transmission mode in the vehicle retrofitted with the non-original powertrain without the OEM body control module. Method 5000 includes at 5100 receiving, by one or more processor, one or more control signals in response to driver activation of a gear or gear range, and at 5200 forwarding, by the one or more processor, data via a vehicle communication bus to the OEM transmission control module so that the OEM transmission control module is operable to control the transmission gear or gear ranges of the non-original powertrain without the body control module to operate the vehicle under manumatic transmission mode.

In other embodiments of the present disclosure, an aftermarket manumatic transmission module may be configurable so as to be adapted for use in more than one different manufacturers of non-original powertrains. An aftermarket manumatic transmission module may be selectably setup by an installer of an aftermarket manumatic transmission module in a vehicle retrofitted with a non-original powertrain. For example, such an aftermarket manumatic transmission module may include memory with separate data or libraries for use with different OEM engine control modules by different manufactures such as General Motors and Ford Motor Company. Upon installation, such an aftermarket manumatic transmission module may be operably sent up or coded to the desired OEM transmission control module.

From the present description, the technique of the present disclosure provides aftermarket manumatic transmission kits and systems that overcome the problem of an OEM transmission control module and an OEM body control module in a retrofitted vehicle having a non-original powertrain being unsatisfactory in providing manumatic transmission mode in the retrofitted vehicle since the additional electronic accessories are not present in the retrofitted vehicle.

The present disclosure is further directed to aftermarket combined cruise control and manumatic transmission control kits and systems for use in, for example, effecting cruise control and manual shift control of automatic transmissions in vehicles retrofitted with non-original powertrains. For example, aftermarket combined cruise control and manumatic transmission control kits and systems may combine the cruise control and manumatic transmission control features described above.

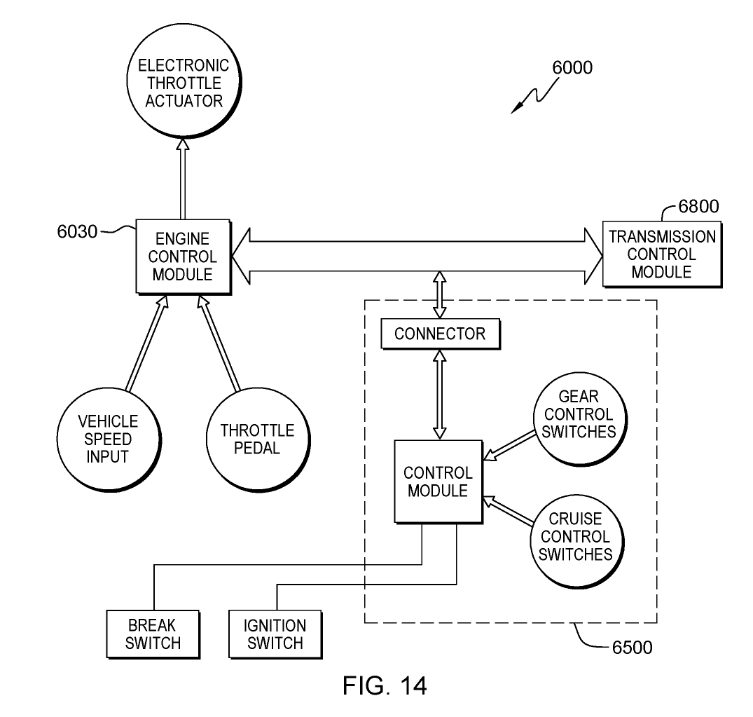

FIG. 14 illustrates a portion of a non-original powertrain 6000 having an aftermarket control system 6500 according to the present disclosure retrofitted in a vehicle for effecting cruise control and manumatic transmission control. Aftermarket control system 6500 is operable for effecting cruise control and manumatic transmission operation in the retrofitted vehicle with the non-original powertrain having an OEM engine control module 6430 with factory installed algorithms for controlling cruise control and an OEM transmission control module 6800 with factory installed algorithms for controlling manumatic transmission operation and without use of the OEM body control module. From the present description, it will be appreciated that the features of the above aftermarket cruise control kits and systems and manumatic transmission control kits and systems may be incorporated in aftermarket control system 6500.

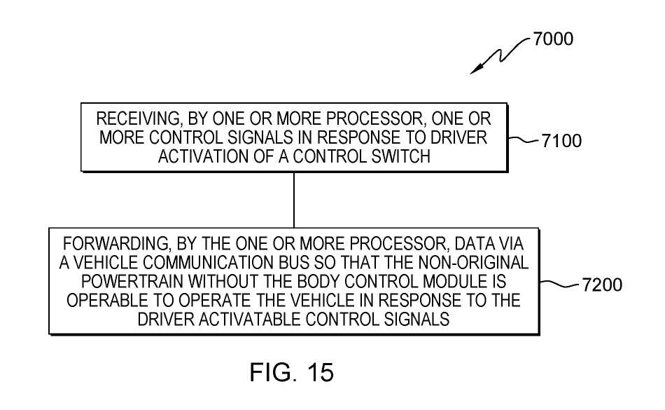

FIG. 15 illustrates a method 7000 for effecting control in a vehicle retrofitted with a non-original powertrain in which the non-original powertrain is configured for operation with an engine control module, a transmission control module, and a body control module, and the method is operable to effect control of the vehicle retrofitted with the non-original powertrain without the body control module. Method 7000 includes at 7100 receiving, by one or more processor, one or more control signals in response to driver activation of a control switch, and at 7200 forwarding, by the one or more processor, data via a vehicle communication bus so that the non-original powertrain without the body control module is operable to operate the vehicle in response to the driver activatable control signals.

A sample of systems and methods that are described herein follows:

A1. An aftermarket cruise control kit for use in a vehicle retrofitted with a non-original powertrain, the non-original powertrain configured for operation with an OEM engine control module and an OEM body control module, said kit operable to effect cruise control in the vehicle retrofitted with the non-original powertrain without the OEM body control module, said kit comprising: an aftermarket cruise control module operably connectable to the OEM engine control module of the powertrain in the vehicle; and said aftermarket cruise control module adapted to received control signals from a cruise control switch and provide data to the OEM engine control module so that the OEM engine control module is operable to control an electronic throttle actuator of the non-original powertrain to operate the vehicle under cruise control. A2. The kit of claim A1 wherein the vehicle comprises an older vehicle and the non-original powertrain comprises a newer powertrain. A3. The kit of claim A1 further comprising the cruise control switch operably connectable to said aftermarket cruise control module and positionable in the vehicle for access by a driver in the vehicle. A4. The kit of claim A1 wherein said aftermarket cruise control module is connectable to a communication bus in the vehicle, which communication bus being connectable to the OEM engine control module. A5. The kit of claim A1 wherein said aftermarket cruise control module is operably connectable to a brake pedal in the vehicle, and said aftermarket cruise control module adapted to disengage the vehicle operating under cruise control in response to the driver engaging the brake. A6. The kit of claim A1 wherein said aftermarket cruise control module is operably connectable to an ignition switch in the vehicle for powering said aftermarket cruise control module. A7. The kit of claim A1 wherein said aftermarket cruise control module is operably connectable to a brake pedal switch in the vehicle and to an ignition switch in the vehicle. A8. The kit of claim A1 wherein said aftermarket cruise control module adapted for use with a plurality of different manufacturer non-original powertrains. A9. The kit of claim A1 wherein said aftermarket cruise control module comprises a connector configured to connect to a communication bus of the vehicle, which communication bus being connectable to the OEM engine control module. A10. The kit of claim A9 wherein said connector is configured to releasably connect to a diagnostic connector connected to the communication bus. A11. The kit of claim A1 wherein said cruise control switch is wired or wirelessly connectable to the cruise control module. A24. A method comprising: providing the aftermarket cruise control kit of claim A1; operably connecting the aftermarket cruise control module to the OEM engine control module in the vehicle; and connecting a cruise control switch in the vehicle to the aftermarket cruise control module.

B1. An aftermarket cruise control system for use in a vehicle retrofitted with a non-original powertrain, the non-original powertrain configured for operation with an OEM engine control module and an OEM body control module, said kit operable to effect cruise control in the vehicle retrofitted with the non-original powertrain without the OEM body control module, said system comprising: an aftermarket cruise control module operably connectable to the OEM engine control module of the powertrain in the vehicle; a cruise control switch operably connectable to said aftermarket cruise control module and positionable in the vehicle for access by a driver in the vehicle; and said aftermarket cruise control module adapted to received control signals from said cruise control switch and provide data to the OEM engine control module so that the OEM engine control module is operable to control an electronic throttle actuator of the non-original powertrain to operate the vehicle under cruise control. B2. The system of claim B1 wherein the vehicle comprises an older vehicle and the non-original powertrain comprises a newer powertrain. B3. The system of claim B2 wherein said aftermarket cruise control module is connectable to a communication bus in the vehicle, which communication bus being connectable to the OEM engine control module. B4. The system of claim B1 wherein said aftermarket cruise control module is operably connectable to a brake pedal in the vehicle, and said aftermarket cruise control module adapted to disengage the vehicle operating under cruise control in response to the driver engaging the brake. B5. The system of claim B1 wherein said aftermarket cruise control module is operably connectable to an ignition switch in the vehicle for powering said aftermarket cruise control module. B6. The system of claim B1 wherein said aftermarket cruise control module is operably connectable to a brake pedal switch in the vehicle and to an ignition switch in the vehicle. B7. The system of claim B1 wherein said aftermarket cruise control module adapted for use with a plurality of different manufacturer non-original powertrains. B8. The system of claim B1 wherein said aftermarket cruise control module comprises a connector configured to connect to a communication bus of the vehicle, which communication bus being connectable to the OEM engine control module. B9. The system of claim B8 wherein said connector is configured to releasably connect to a diagnostic connector connected to the communication bus. B10. The system of claim B1 wherein said cruise control switch is wired or wirelessly connectable to the aftermarket cruise control module. B11. The system of claim B1 further comprising the powertrain. B12. The system of claim B1 further comprising the vehicle. B13. A method comprising: providing the aftermarket cruise control system of claim B1; operably connecting the aftermarket cruise control module to the OEM engine control module in the vehicle; and connecting the cruise control switch in the vehicle to the aftermarket cruise control module.

C1. A method for effecting cruise control in a vehicle retrofitted with a non-original powertrain, the non-original powertrain configured for operation with an OEM engine control module and an OEM body control module, the method operable to effect cruise control in the vehicle retrofitted with the non-original powertrain without the OEM body control module, the method comprising: receiving, by one or more processor, one or more control signals in response to driver activation of a cruise control switch; and forwarding, by the one or more processor, data via a vehicle communication bus to the OEM engine control module so that the OEM engine control module is operable to control an electronic throttle actuator of the non-original powertrain without the body control module to operate the vehicle under cruise control. C2. The method of claim C1 further comprising receiving, by the one or more processor, a signal from a brake switch, and sending, by the one or more processor, data to the OEM engine control module for disengaging cruise control. C3. The method of claim C1 wherein the forwarding comprises forwarding by the one or more processor the one or more messages to the OEM engine control module via a communication bus.

D1. An aftermarket manumatic transmission control kit for use in a vehicle retrofitted with a non-original powertrain, the non-original powertrain configured for operation with an OEM engine control module, an OEM transmission control module, and an OEM body control module, said kit operable to effect manumatic transmission control in the vehicle retrofitted with the non-original powertrain without the OEM body control module, said kit comprising: an aftermarket manumatic transmission control module operably connectable via a communication bus in the vehicle to the OEM transmission control module of the powertrain in the vehicle; and said aftermarket manumatic transmission control module adapted to receive control signals from a gear control switch and provide data to the OEM transmission control module so that the OEM transmission control module is operable to operate the vehicle under driver control of the gear selection. D2. The kit of claim D1 wherein the vehicle comprises an older vehicle and the non-original powertrain comprises a newer powertrain. D3. The kit of claim D1 further comprising said gear control switch operably connectable to said aftermarket gear control module and positionable in the vehicle for access by a driver in the vehicle. D4. The kit of claim D1 wherein said aftermarket manumatic transmission control module is operably connectable to an ignition switch in the vehicle for powering said aftermarket manumatic transmission control module. D5. The kit of claim D1 wherein said aftermarket manumatic transmission control module is adapted for use with a plurality of different manufacturer non-original powertrains. D6. The kit of claim D1 wherein said aftermarket manumatic transmission control module comprises a connector configured to connect to the communication bus of the vehicle, which communication bus being connectable to the OEM transmission control module. D7. The kit of claim D6 wherein said connector is configured to releasably connect to a diagnostic connector connected to the communication bus. D8. The kit of claim D1 wherein said gear control switch is wired or wirelessly connectable to the manumatic transmission control module. D9. A method comprising: providing the aftermarket manumatic transmission control kit of claim D1; operably connecting the aftermarket manumatic transmission control module to the OEM transmission control module in the vehicle; and connecting a gear control switch in the vehicle to the aftermarket manumatic transmission control module.

E1. An aftermarket manumatic transmission control system for use in a vehicle retrofitted with a non-original powertrain, the non-original powertrain configured for operation with an OEM engine control module, an OEM transmission control module, and an OEM body control module, said system operable to effect manumatic transmission control in the vehicle retrofitted with the non-original powertrain without the OEM body control module, said system comprising: an aftermarket manumatic transmission control module operably connectable via a communication bus in the vehicle to the OEM transmission control module of the powertrain in the vehicle; a gear control switch operably connectable to said aftermarket manumatic transmission control module and positionable in the vehicle for access by a driver in the vehicle; and said aftermarket manumatic transmission control module adapted to receive control signals from said gear control switch and provide data to the OEM transmission control module so that the OEM transmission control module is operable to operate the vehicle under driver control of the gear selection. E2. The system of claim E1 wherein the vehicle comprises an older vehicle and the non-original powertrain comprises a newer powertrain. E3. The system of claim E1 wherein said aftermarket manumatic transmission control module is operably connectable to an ignition switch in the vehicle for powering said aftermarket manumatic transmission control module. E4. The system of claim E1 wherein said aftermarket manumatic transmission control module is adapted for use with a plurality of different manufacturer non-original powertrains. E5. The system of claim E1 wherein said aftermarket manumatic transmission control module comprises a connector configured to connect to the communication bus of the vehicle, which communication bus being connectable to the OEM transmission control module. E6. The system of claim E5 wherein said connector is configured to releasably connect to a diagnostic connector connected to the communication bus. E7. The system of claim E1 wherein said gear control switch is wired or wirelessly connectable to the aftermarket manumatic transmission control module. E8. The system of claim E1 further comprising the powertrain. E9. The system of claim E1 further comprising the vehicle. E10. A method comprising: providing the aftermarket manumatic transmission control system of claim E1; operably connecting the aftermarket manumatic transmission control module to the OEM transmission control module in the vehicle; and connecting the gear control switch in the vehicle to the aftermarket manumatic transmission control module.

F1. A method for effecting manumatic transmission control in a vehicle retrofitted with a non-original powertrain, the non-original powertrain configured for operation with an OEM engine control module, an OEM transmission control module, and an OEM body control module, the method operable to effect manumatic transmission control in the vehicle retrofitted with the non-original powertrain without the OEM body control module, the method comprising: receiving, by one or more processor, one or more control signals in response to driver activation of a gear control switch; and forwarding, by the one or more processor, data to the OEM transmission control module so that the OEM transmission control module is operable to operate the vehicle under driver control of the gear selection. F2. The method of claim F1 wherein the forwarding comprises forwarding by the one or more processor the one or more messages to the OEM transmission control module via a communication bus.

It is to be understood that the above description is intended to be illustrative, and not restrictive. Numerous changes and modifications may be made herein by one of ordinary skill in the art without departing from the general spirit and scope of the disclosure as defined by the following claims and the equivalents thereof. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Also, the term “operably” in conjunction with terms such as coupled, connected, joined, sealed or the like is used herein to refer to both connections resulting from separate, distinct components being directly or indirectly coupled and components being integrally formed (i.e., one-piece, integral or monolithic). Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure. It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments have been described, it is to be understood that aspects of the disclosure may include only some of the described embodiments. Accordingly, the disclosure is not to be seen as limited by the foregoing description, but is only limited by the scope of the appended claims.

This written description uses examples, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An aftermarket control kit for use in a vehicle retrofitted with a non-original powertrain, the non-original powertrain configured for operation with an engine control module, a transmission control module, and a body control module, said kit operable to effect control of the non-original powertrain without the body control module in the retrofitted vehicle, said kit comprising:
an aftermarket control module operably connectable to the non-original powertrain via a vehicle communication bus in the retrofitted vehicle without the body control module; and
said aftermarket control module adapted to receive control signals from a driver activatable control switch and provide data via the vehicle communication bus so that the non-original powertrain without the body control module is operable to operate the vehicle in response to the driver activatable control signals.

2. The kit of claim 1 wherein said aftermarket control module comprises an aftermarket cruise control module; and
said aftermarket cruise control module operably connectable to the engine control module of the non-original powertrain via the vehicle communication bus in the retrofitted vehicle without the body control module; and
said aftermarket cruise control module adapted to receive said control signals from said control switch comprising a cruise control switch and provide data via the vehicle communication bus to the engine control module so that the engine control module of the non-original powertrain without the body control module is operable to control an electronic throttle actuator of the non-original powertrain to operate the vehicle under cruise control.

3. The kit of claim 2 wherein said aftermarket cruise control module is operably connectable to a brake pedal in the vehicle, and said aftermarket cruise control module adapted to disengage the vehicle operating under cruise control in response to the driver engaging the brake.

4. The kit of claim 1 wherein said aftermarket control module comprises an aftermarket manumatic transmission control module; and
said aftermarket manumatic transmission control module operably connectable to the transmission control module of the non-original powertrain via the vehicle communication bus in the retrofitted vehicle without the body control module; and
said aftermarket manumatic transmission control module adapted to receive said control signals from said control switch comprising a gear control switch and provide data via the vehicle communication bus to the transmission control module so that the transmission control module of the non-original powertrain without the body control module is operable to operate the vehicle under driver control of the gear selection.

5. The kit of claim 1 wherein the vehicle comprises an older vehicle and the non-original powertrain comprises a newer powertrain.

6. The kit of claim 1 further comprising the control switch operably connectable to said aftermarket control module and positionable in the vehicle for access by a driver in the vehicle.

7. The kit of claim 6 wherein said control switch is wired or wirelessly connectable to the aftermarket control module.

8. The kit of claim 1 wherein said aftermarket control module is adapted for use with a plurality of different manufacturer non-original powertrains.

9. The kit of claim 1 further comprising a connector configured to connect to the vehicle communication bus of the vehicle.

10. The kit of claim 9 wherein said connector is configured to releasably connect to a diagnostic connector connected to the vehicle communication bus.

11. The kit of claim 1 wherein said aftermarket control module is operably connectable to an ignition switch in the vehicle for powering said aftermarket control module.

12. An aftermarket control system for use in a vehicle retrofitted with a non-original powertrain, the non-original powertrain configured for operation with an engine control module, a transmission control module, and a body control module, said system operable to effect control of the non-original powertrain without the body control module in the retrofitted vehicle, said system comprising:
an aftermarket control module operably connectable to the non-original powertrain via a vehicle communication bus in the retrofitted vehicle without the body control module;
a driver activatable control switch operably connectable to said aftermarket control module and positionable in the vehicle for access by a driver in the vehicle;
a connector configured to connect said aftermarket control module to the vehicle communication bus of the vehicle; and
said aftermarket control module adapted to receive control signals from said driver activatable control switch and provide data via the vehicle communication bus so that the non-original powertrain without the body control module is operable to operate the vehicle in response to the driver activatable control signals.

13. The system of claim 12 wherein said aftermarket control module comprises an aftermarket cruise control module; and
said aftermarket cruise control module operably connectable to the engine control module of the non-original powertrain via the vehicle communication bus in the retrofitted vehicle without the body control module;
said driver activatable control switch comprises a cruise control switch; and
said aftermarket cruise control module adapted to receive said control signals from said cruise control switch and provide data via the vehicle communication bus to the engine control module so that the engine control module of the non-original powertrain without the body control module is operable to control an electronic throttle actuator of the non-original powertrain to operate the vehicle under cruise control.

14. The system of claim 13 wherein said aftermarket cruise control module is operably connectable to a brake pedal in the vehicle, and said aftermarket cruise control module adapted to disengage the vehicle operating under cruise control in response to the driver engaging the brake.

15. The system of claim 12 wherein said aftermarket control module comprises an aftermarket manumatic transmission control module; and
said aftermarket manumatic transmission control module operably connectable to the transmission control module of the non-original powertrain via the vehicle communication bus in the retrofitted vehicle without the body control module;
said driver activatable control switch comprises a gear control switch; and
said aftermarket manumatic transmission control module adapted to receive said control signals from said gear control switch and provide data via the vehicle communication bus to the transmission control module so that the transmission control module of the non-original powertrain without the body control module is operable to operate the vehicle under driver control of the gear selection.

16. The system of claim 12 further comprising the non-original powertrain.

17. The system of claim 12 further comprising the vehicle.

18. A method comprising:
providing the aftermarket control kit of claim 1;
operably connecting the aftermarket control module to the non-original powertrain in the vehicle; and
connecting a control switch in the vehicle to the aftermarket control module.

19. A method comprising:
providing the aftermarket control system of claim 12;
operably connecting the aftermarket control module to the non-original powertrain in the vehicle; and
connecting the control switch in the vehicle to the aftermarket control module.

20. A method for effecting control in a vehicle retrofitted with a non-original powertrain, the non-original powertrain configured for operation with an engine control module, a transmission control module, and a body control module, the method operable to effect control of the vehicle retrofitted with the non-original powertrain without the body control module, the method comprising:
receiving, by one or more processor, one or more control signals in response to driver activation of a control switch; and
forwarding, by the one or more processor, data via a vehicle communication bus so that the non-original powertrain without the body control module is operable to operate the vehicle in response to the driver activatable control signals.

21. The method of claim 20 wherein:
the receiving comprises receiving, by the one or more processor, the one or more control signals in response to driver activation of a cruise control switch; and
the forwarding comprises forwarding, by the one or more processor, the data via the vehicle communication bus to an engine control module so that the engine control module is operable to control an electronic throttle actuator of the non-original powertrain to operate the vehicle under cruise control.

22. The method of claim 21 further comprising receiving, by the one or more processor, a signal from a brake switch, and forwarding, by the one or more processor, data via the vehicle communication bus to the engine control module for disengaging cruise control.

23. The method of claim 20 wherein:
the receiving comprises receiving, by the one or more processor, the one or more control signals in response to driver activation of a gear control switch; and
he forwarding comprises forwarding, by the one or more processor, the data to a transmission control module so that the transmission control module is operable to operate the vehicle under driver control of the gear selection.
